(19) United States
(12) Patent Application Publication
(10) Pub. No.: US 2018/0253287 A1
(43) Pub. Date: Sep. 6, 2018

(54) METHOD FOR TRANSLATION OF ASSEMBLER COMPUTER LANGUAGE TO VALIDATED OBJECT-ORIENTED PROGRAMMING LANGUAGE

(71) Applicants: Jian Wang, Sterling, VA (US); Zhenqiang Yu, Rockville, MD (US); Yan Cheng, Great Falls, VA (US)

(72) Inventors: Jian Wang, Sterling, VA (US); Zhenqiang Yu, Rockville, MD (US); Yan Cheng, Great Falls, VA (US)

(21) Appl. No.: 15/582,563

(22) Filed: Apr. 28, 2017

Related U.S. Application Data
(63) Continuation of application No. 15/447,098, filed on Mar. 1, 2017, now abandoned.

(51) Int. Cl. G06F 9/45; G06F 9/44

(52) U.S. Cl. CPC G06F 8/447; G06F 8/433; G06F 8/315

(57) ABSTRACT

The method for translation of assembler computer language to validated object-oriented programming language converts Assembler Language Code (ALC) logical processes to equivalent object-oriented processes. The method uses various iteratively updated rules sets and graphical analysis tools to automate the translation process. The method further uses a Technical Rule Language (TRL) as an intermediate scripting language to map ALC sequential instruction sets to simplified Java constructs, which are verified and then translated to Java executable code.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF THE INVENTION

This invention relates to the field of data processing and more specifically to a method for translating a legacy program written in Assembler Language Code into a high-level object-oriented programming language.

### BACKGROUND OF THE INVENTION

U.S. government agencies routinely rely on outdated computer programs referred to as “legacy” applications. A legacy application is a program written for an operating system no longer used or sold, Many of these programs were written in the 1960's and 1970's for the IBM 360 and successor mainframe computers. The programs are functional, but increasingly difficult to update and do not reflect technological advancements and efficiencies of development of powerful computer languages such as Java and C++.

The IRS, for example, currently has a system of applications written in IBM Assembler Language Code (ALC), requiring it to maintain more than 10 million source lines of code. The IRS is currently migrating two mission-critical “runs” which perform the core of individual tax processing. These two runs consist of about 350,000 lines of ALC with densely packed processing logic and interdependencies.

Rewriting programs in Java requires programmers skilled in ALC to harvest system requirements and write a new program, trying to equate the functionality using modern programming logic, Since ALC is no longer in use, the IRS must recruit and/or train specialized task forces of programmers. The IRS must maintain adequate levels of supervision to mitigate the risk of error associated with the migration process.

The IRS and other government agencies have attempted to translate assembler code into Java using automated tools and the legacy source code as the input.

There are several problems known in the art with respect translating “low-level” programs from ALC languages to a “high-level” programming language like Java. Low-level computer languages, dating back to 1968, were not designed to be portable or reused on operating systems other than those for which they were designed. Modern programs define standard data “types,” and allow programmers to define their own types. In modern languages, data types are names or other identifiers that convey how code is used by a program; the types remain constant so that code can be readily understood by programmers familiar with standard data types. Standard data types are used and reused in a wide range of programs and functions. Data types are populated with values as a program is run. The concept of data type allows code to be reused and universally understood, or “portable.”

ALC does not have a concept equivalent to data type. Instead, ALC programs are focused on rapid storage and retrieval of data. Instead of being associated with a data type, data is defined by unique storage locations from which the data is retrieved.

ALC requires specific instructions for a processor, telling it to move data to or from its registers, which are specific locations in memory or data structures unique to the operating each operating system. Each instruction in assembly code is converted into one piece of machine code. Instructions are “assembled” within the processor and direct the processor to perform logical operations by retrieving, comparing, and storing data from memory.

In assembler languages, there is a one-to-one relationship between code and instructions. In contrast, a single instruction in Java invokes a standardized function that performs a series of data retrieval and logical operational functions, referencing data by name rather than by storage location.

In Java, standard functions and data types are given intuitive, semantic names, and are stored in “libraries” of functions for programmers to draw upon. A modern programmer does not need to know anything about the specific logical operations performed to carry out a program function, and does not need to know where data is stored in memory. This feature, referred to as “abstraction,” makes programs written in modern languages highly portable across operating systems and extremely efficient.

Several problems are known in the art with respect to developing translation tools to map ALC functions to Java. One problem is the lack of standardized subroutines and sequences which can be identified and mapped to Java functions. Basic conditional logic (if-then-else/loops) does not exist in assembler language, and instead a processor is manipulated with low level “go to” commands, pointers, and offset data labels.

Another problem known in the art is indirect addressing. ALC uses offsets and addresses to physical memory locations to perform byte-level operations. ALC often requires programmers to refer directly to memory references in the code itself. There is no equivalent to this concept in Java and other high level languages.

Since ALC does not use standard data types, a program may use multiple variable names to identify similar data. Data is identified by memory address. A single physical data element in an assembler language may be defined as several different data types, and the determination of data type depends on where the variable appears in the program. A standard practice in ALC is to use “indirect addressing” as a means for abstract knowledge of the physical memory location away from the application.

There is an unmet need in the art for ALC migration tools which can receive assembler language as input and logically translate the code to object-oriented programming languages.

There is a further unmet need in the art for translation tools and methods which can verify the accuracy of code that has been translated from assembler language to object-oriented programming languages.

### BRIEF SUMMARY OF THE INVENTION

The invention involves methods of translation of assembler language code (ALC) into validated object-oriented programming language, referred to herein as the target language. In the exemplary embodiment described, the target language is Java, but may be any object-oriented programming language known in the art.

In various embodiments, the method converts ALC logical processes to equivalent object-oriented processes. The method uses various iteratively updated rules sets and graphical analysis tools to automate the translation process. The method further uses a Technical Rule Language (TRL) as an intermediate scripting language which maps ALC sequential instruction sets to simplified Java constructs, which are verified and then translated to Java executable code. In various embodiments, mapping may be accomplished by the use of graphical interface tools. At various steps in the translation process, accuracy of translated code may be verified and validated using data structures and functions novel to the method.

### Terms of Art

As used herein, the term “Assembler Language Code (ALC)” means a low-level programming language for a computer, or other programmable device, in which there is a very strong (generally one-to-one) correspondence between the language and the architecture's machine code instructions. Each assembly language is specific to a particular computer architecture.

As used herein, the term “Analyzer Tool” means a set of functions to analyze a run of ALC and provide information about the code including but not limited to subroutines, self-modified code, and certain patterns.

As used herein, the term “block” or “run” means a section of ALC which has been isolated for processing, which may or may not be functionally related in some manner.

As used herein, the term “Configuration Files” means files which contain Analyzer Tool and SME inputs.

As used herein, the term “Control Flow Graph (CFG)” means a graphical representation of how instructions or function calls of an imperative program are executed or evaluated.

As used herein, the term “Data Extraction Tool” means one or more functions which parse and scan the source ALC for lines of code that contain schema information about how data variables are defined and how the data is stored in physical memory.

As used herein, the term “data” includes data values and schema.

As used herein, the term “dump” or “memory dump” means a set of data used for analysis and/or verification, a process in which the contents of memory are displayed and stored.

As used herein, the term “Individual Master File (IMF)” means an ALC application that receives data from multiple sources.

As used herein, the term “Java Data Objects” means objects generated by the Data Extraction Tool which contain data necessary in a runtime environment.

As used herein, the term “Java Object Model (JOM)” refers to an object which contains extracted data structure definitions that can be directly traced back to ALC or another legacy program.

As used herein, the term “Java Runtime Environment” means a software package that contains what is required to run a Java program.

As used herein, the term “legacy language” means ALC or any language specific to a particular operating system which must be translated to an object-oriented programming language or another target language.

As used herein, the term “normalizing” means any process of conforming schema and logic within a programming language to any rule or standard, e.g., in furtherance of translation from one language to another.

As used herein, the term “rule(s) engine” means software to infer consequences or perform functions based on conditions or facts. There are also examples of probabilistic rule engines, including Pei Wang's non-axiomatic reasoning system, and probabilistic logic networks.

As used herein, the term “schema” means a description of the attributes and location of data.

As used herein, the term “self-modifying code” means code that alters its own instructions while it is executing, in which the self-modification is intentional.

As used herein, the term “sequential file format” means a file format which preserves a data sequence (e.g., a data sequence used by a particular application).

As used herein, the term “SME” or “subject matter expert” means humans with training to perform verification and analysis, or to modify a computer program.

As used herein, the term “target language” means a language to which legacy code is translated.

As used herein, the term “Technical Rule Language (TRL)” means a script/procedure language specially designed to capture ALC constructs and provide a separation between ALC data and program flows, and to provide limited Java functions and class definitions to facilitate translation.

As used herein, the term “Tool” means a group of two or more related functions.

As used herein, the term “Translator Tool” means a group of functions to convert ALC execution logic into TRL using pattern recognition or configuration rules.

As used herein, the term “TRL/Java Engine” means a computer processor for executing Java code.

### BRIEF DESCRIPTION OF THE DRAWINGS

FIG. 1 illustrates an exemplary embodiment of a method for translation of ALC into validated object-oriented programming language.

FIG. 2 illustrates an exemplary flow diagram of an ALC to Java translation approach in which processing logic and data definition are processed in two parallel steps.

### DETAILED DESCRIPTION OF THE INVENTION

For the purpose of promoting an understanding of the present invention, references are made in the text to exemplary embodiments of a method 100 for translation of ALC into validated object-oriented programming language, only some of which are described herein. It should be understood that no limitations on the scope of the invention are intended by describing these exemplary embodiments. One of ordinary skill in the art will readily appreciate that alternate but functionally equivalent functions, steps, logical conventions or exemplary code coding may be used. The inclusion of additional steps or elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings, flowcharts, and diagrams are exemplary only and that emphasis has been placed upon illustrating the principles of the invention. Steps may be performed in any order. In addition, in the embodiments depicted herein, like reference numerals in the various drawings refer to identical or near identical structural elements.

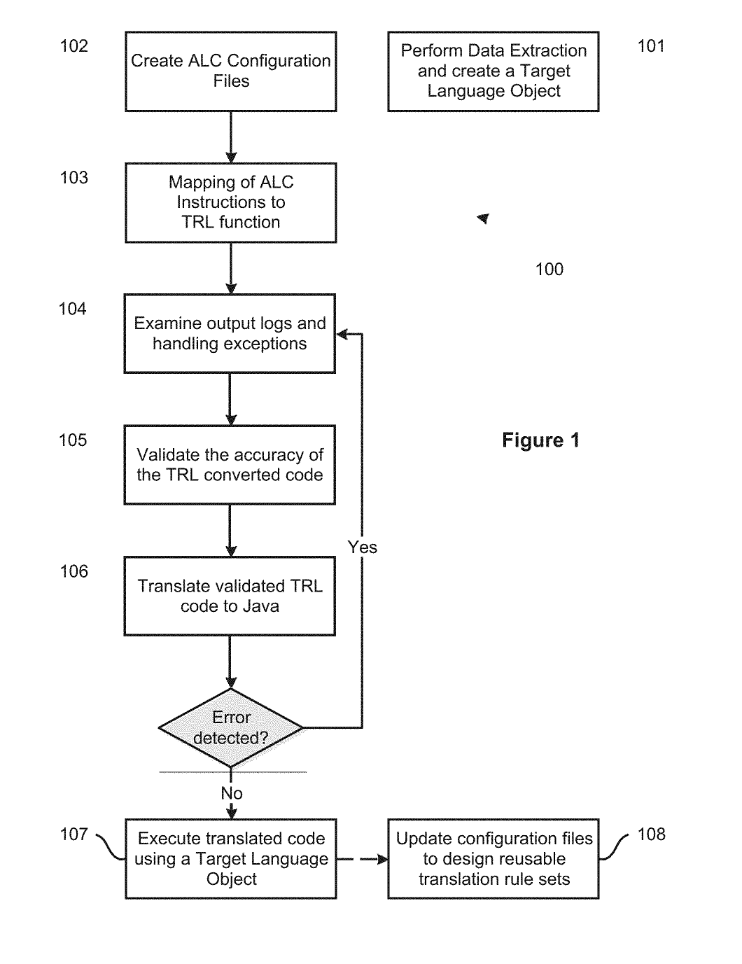

FIG. 1 illustrates an exemplary embodiment of method 100 for translation of ALC into validated object-oriented programming language. In the exemplary embodiment of method 100 described, the target language is Java, but may be any object-oriented programming language known in the art.

Method 100 uses various iteratively updated rules sets and graphical analysis tools to automate translation process. Method 100 further uses a Technical Rule Language (TRL) as an intermediate scripting language to describe constructs in ALC. The TRL maps ALC instructions to simplified Java constructs, which are then translated to Java executable code which may be verified and tested using various techniques novel to method 100.

Step 101 is the step of performing Data Extraction and creating a Target Language Object, During this step, various Data Extraction functions of the Data Extraction Tool parse and scan the source ALC for lines of code that contain schema information about data variables defined in ALC (e.g., type, length, etc.) and how (e.g., hexidec) the data is stored in physical memory. The Data Extraction Tool provides information about the data storage that is required for the Java Runtime Environment in the exemplary embodiment shown.

Step 101 further includes the step of creating a Target Language Object, which in the exemplary embodiment shown, is a Java Data Object.

In various embodiments, the Data Extraction Tool provides the information (metadata) necessary to read input data and write output data in a sequential file format used by the legacy application.

In various embodiments, Step 101 may include generating a sequential file format in legacy application source code using various simulation and validation functions.

Step 102 is the step of creating ALC Configuration Files. This step defines the logical code blocks in which to split the code for ALC to TRL translation. These logical cutting points for the processing code are provided for ALC to TRL translation in the form of Configuration Files. Configuration Files include Analyzer Tool and the ALC inputs

In Step 102, the ALC Analyzer Tool runs diagnostic functions to generate ALC statistics such as the number of well-formed subroutines, number of self-modified code for certain patterns and various conventional and non-conventional coding practices. The Analyzer Tool supports manual constructing configuration rules and produces some automated configuration rules. Configuration rules may be further refined by IMF/ALC SMEs.

Step 103 is the step of mapping ALC logic to TRL Translator Tool functions to further process Configuration Files containing SME work product and inputs from the Analyzer Tool.

In various embodiments, the ALC to TRL Translator Tool function may represent the code as a Control Flow Graph (CFG). In various embodiments, CFG pattern recognition may be used to identify simple and complex ALC patterns in a control flow graph to automatically translate the code into logical and human understandable patterns

In CFG pattern recognition, an algorithm is invoked to detect and reduce coding patterns which correspond to familiar structured coding instructions which are available in TRL. This process simplifies the CFG and from the simplified graph the tool produces translated TRL code. A CFG Tool converts ALC execution logic into TRL by identifying patterns in the source code and converts these patterns into modern language constructs found in Java.

In various embodiments, the CFG Tool may automatically convert portions ALC listing code into TRL. In other embodiments, CFG Tool may require human configurations to handle special code logic like self-modified code, macros, and the converted code structure.

Step 104 is the step of iteratively examining output logs and handling exceptions. The converted code is reviewed by SMEs to identify the un-handled ALC and define handling protocols. Any “hard-to-read” converted code is specially handled by SMEs who manually regenerate readable TRL. Special handling instructions are added to the configuration files to instruct the translation tools on how to regenerate TRL. This may result in multiple iterations until the TRL meets the criteria to pass the step.

Step 105 is the step of validating the accuracy of the TRL converted code. One exemplary approach to mimic the legacy data structures to allow for precise validation of intermediate outputs, by memory dumps and comparing byte per byte. The execution path verification validates that the steps on the original ALC and translated TRL are equivalent. These unique validation strategies easily pinpoint bugs for correction.

Validation may also be performed by execution path verification. The execution path of both the original ALC and the resulting Java can also be tracked and compared to verify 100% accuracy of the results.

In method 100, TRL is used as an intermediate scripting language to accurately describe the source ALC using modern language constructs and can easily be converted into Java executable in the runtime environment.

TRL is a high level script/procedure language specially designed to capture ALC constructs and provide a separation between ALC data and program flows (i.e., logical processes). Since TRL is a procedure-like language, a large number of resulting TRL statements are one-to-one translations of the original ALC instructions. This allows for easy traceability of the translated TRL code to ALC statements or logical code blocks for verification. Furthermore, the separation of data and processing logic lays down the foundation for easy TRL to Java translation.

In the exemplary embodiment shown, TRL performs several critical functions during the ALC to Java translation process and operates as a transitional programing language for programmers having only ALC or Java skillsets. TRL is a very simple high level structured language with a minimum set of features sufficient enough to translate ALC to Java. Users with only ALC background will find it easier to learn TRL than Java. Likewise, users with only a Java background will find it easier to learn TRL than ALC.

TRL is a specially designed language to describe ALC constructs in a structured way which allows the stackless ALC constructs to be converted into structured language that is both understood by legacy developers and modern developers. In one embodiment, TRL is a programming language developed at the IRS for the purpose of translating IBM mainframe ALC to Java and for extracting business rules from the IMF. The TRL language was designed with a number of key features to support the translation from ALC to Java. The TRL is intended to include only a minimal subset of Java language features; enough to translate the ALC.

In various embodiments, TRL may be executed in a Java Virtual Machine (JVM). In addition, TRL as its own language can easily add features needed for ALC translation that are not native in the Java language.

In the exemplary embodiment shown, TRL supports various discover-and-translate functions. These functions minimize language features that are needed for the translation in order to reduce the complexity of the intermediary language.

Step 106 is the step of translating validated TRL code to Java. Once the TRL code is completely validated, the next step is to automatically translate it to Java.

Step 107 is the step of executing translated code using a Target Language Object. During the final step, the Target Language Object built during the first step is used to execute the Java code on the TRL/Java engine. In various embodiments, a two-layer model or a five-layer model may be produced.

The two-layer data model corresponds to the ALC data structures. Validation using the two-layer validation can be done as well, byte per byte on intermediate results. The execution path of both the original ALC and the resulting Java can also be tracked and compared to verify 100% accuracy of the results.

In other embodiments, TRL may be a part of five-layer software architecture targeting future states and is intended to be the basis for the future IRS Business Rule Language (IRS-BRL)

Various embodiments of method 100 may include a Java runtime engine and a TRL Engine which have been developed to provide modern runtime supports for TRL (e.g., tracing, exception handling, logging, etc.).

Step 108 is the optional step of updating configuration files to design reusable translation rule sets. In various embodiments, TRL uses Configuration Files to improve code conversion productivity, accuracy, and readability. In various embodiments, the Configuration Files may define reusable and repeatable translation rules that can be used for tracking and controlling translation process.

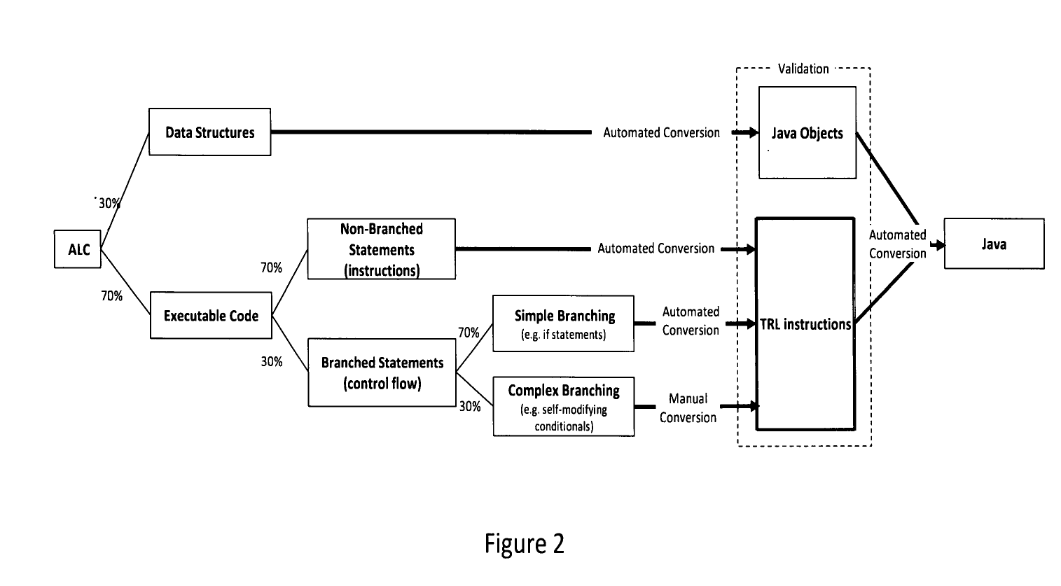

FIG. 2 illustrates an exemplary flow diagram of ALC to Java translation approach in which processing logic and data definition are processed in two parallel steps. Using this process, a majority of instructions will be processed by CFG Tools and algorithms of the ALC to TRL Translator Tool.

The remaining statements will be translated using the Analyzer Tool and configuration rules for “special handling.” The iteratively updated configurable rules are used to tell the Analyzer/Translator Tools how to deal with these anomalies. There are several types of rules, and each type is stored in a separate rule file. Some of these rules can be generated automatically by the Analyzer Tool.

1. A method for verifiable translation of ALC to object-oriented programming code comprised of the steps of:
performing a scanning run of ALC to identify ALC schema;
performing one or more Data Extraction Tool functions comprising:
extracting ALC schema,
extracting data required for a Java Runtime Environment, or creating one or more Configuration Files;
iteratively invoking at least one ALC to TRL Translator Tool function comprised of the steps of:
creating a graphical representation of ALC patterns,
comparing said graph of said ALC patterns to said one of more target language code patterns,
identifying at least one match between at least one ALC pattern and at least one Java code pattern to create a simplified graphical representation,
producing a first TRL code translation corresponding to said simplified graphical representation,
identifying unhandled TRL code,
creating special case handling rules to address said unhandled TRL code; and
updating said Configuration Files to reflect said special case handling rules.

2. The method of claim 1 which further includes validating the accuracy of the TRL converted code by creating sequential legacy data structures and performing an execution path verification function.

3. The method of claim 2 wherein said execution path verification includes performing a memory dump.

4. The method of claim 1 wherein there is a one-to-one relationship between TRL statements and ALC instructions.

5. The method of claim 1 which further includes the step of building Java Object Model.

6. The method of claim 1 which further includes the step of executing code using a Java Runtime Environment and TRL.

7. The method of claim 6 wherein said testing is a process selected from a group consisting of tracing, exception handling, and logging.

8. The method of claim 6 wherein said TRL contains a library of simulated Java version assembler instructions.

9. The method of claim 1 wherein said TRL is comprised of a subset of target language features.

10. The method of claim 1 which further includes the step of performing a memory dump validation.

11. The method of claim 1 which further includes defining logical code blocks into which code is split for processing.

12. The method of claim 1 wherein said TRL engine further includes memory dump based validation.

13. The method of claim 1 which further includes the step of creating a two-layer Java Object Model with Java data corresponding to ALC data.

14. The method of claim 13 which further includes the step of executing a memory dump based validation.

15. The method of claim 1 which further includes automated identification of non-conventional coding practices.

16. The method of claim 1 which further includes the step of using at least one Detect-and-Reduce algorithm to detect use of known patterns and replace them as needed.

17. The method of claim 1 which further includes a function to detect and eliminate fake loops.

18. The method of claim 1 which further includes examining both original and translated code during memory dumps.

19. The method of claim 1 wherein said equivalent Java Runtime Environment data equivalents are selected from a group consisting of type, length, value amount, identifier, sequence, instance, value, index, association, computational result, logical result, associated value, offset, status, condition and attribute value.

20. A computer processor configured to perform ALC to TRL translation comprised of:
a Data Extraction Tool;
an Analyzer Tool;
an ALC to TRL Translator Tool; and
a TRL to Java Translator.
